(19) United States
(12) Patent Application Publication
(10) Pub. No.: US 2026/0172422 A1
(43) Pub. Date: Jun. 18, 2026

(54) AUTOMATED TENANT PROVISIONING

(71) Applicant: MELLANOX TECHNOLOGIES, LTD., Yokneam (IL)

(72) Inventors: Evgeny Tantsura, Emerald Hills, CA (US); Barak Gafni, Sunnyvale, CA (US); Wilson Kok, San Jose, CA (US)

(21) Appl. No.: 19/353,280

(22) Filed: Oct. 8, 2025

Related U.S. Application Data
(60) Provisional application No. 63/735,240, filed on Dec. 17, 2024.

(51) Int. Cl. H04L 9/40

(52) U.S. Cl. CPC H04L 63/0876

(57) ABSTRACT

Systems and methods disclosed herein are for a network to use virtual routing and forwarding (VRF) for tenant provisioning. The network may include a network device and an authentication server or service. The network device may provide an authentication request and a VRF request to the authentication server or service. The authentication server or service may return a VRF reference to the network device. The network device may also place the tenant with a VRF associated with the VRF reference, on behalf of a tenant and as part of a provisioning of resources for the tenant.

### CROSS-REFERENCE TO RELATED APPLICATIONS

This is a Non-Provisional Patent Application which is related to and which claims the benefit of priority to U.S. Provisional Patent Application 63/735,240, filed on Dec. 17, 2024, and entitled “AUTOMATED TENANT PROVISIONING,” which is hereby incorporated by reference herein in its entirety and for all intents and purposes.

### TECHNICAL FIELD

This disclosure generally relates to tenant provisioning in large multi-tenant clusters and specifically relates to use of virtual routing and forwarding (VRF) for tenant provisioning.

### BACKGROUND

Tenant provisioning may include creation and configuration for a multi-tenant environment and may specifically include provisioning for a specific tenant or customer within shared infrastructure of the multi-tenant environment. The creation and configuration may include allocation of resources, assignment of permissions, and set-up of configurations to ensure isolation and security for each tenant or customer. Tenant provisioning may use certain standards available for at least some aspects of the process. For instance, the IEEE® 802.1X® standard defines port-based authentication access control and authentication protocol for aspects of the process for tenant provisioning. The authentication access control and authentication protocol may be used to prevent unauthorized clients from connecting within the mutli-tenant environment. This standard may also be used to provision a user's VLAN (Virtual Local Area Network), once authentication has been successfully performed, for instance. The 802.1X standard, as used, may present a layer mismatch. For instance, the 802.1X standard may operate at Layer 2 (L2, such as represented by the provision of the VLAN) of the OSI (Open Systems Interconnection) standard. Clusters for Artificial Intelligence (AI) may operate at Layer 3 (L2 IP) of the OSI standard. Tenant provisioning may be cumbersome as it may require L2 configuration on the switch that may be complex but that may also be unnecessary.

### BRIEF DESCRIPTION OF DRAWINGS

FIG. 1 illustrates a network that is subject to embodiments of using virtual routing and forwarding (VRF) for tenant provisioning;

FIG. 2 illustrates network aspects for using VRF for tenant provisioning, in one example;

FIG. 3 illustrates modules of an authentication server to support the use of VRF for tenant provisioning, in one example;

FIG. 4 illustrates computer and processor aspects of a system for using VRF for tenant provisioning, in one example;

FIG. 5 illustrates a process flow in a system for using VRF for tenant provisioning, in one example;

FIG. 6 illustrates yet another process flow for an authentication server to support tenant provisioning, in one example; and

FIG. 7 illustrates a further process flow for a switch to support tenant provisioning, in one example.

### DETAILED DESCRIPTION

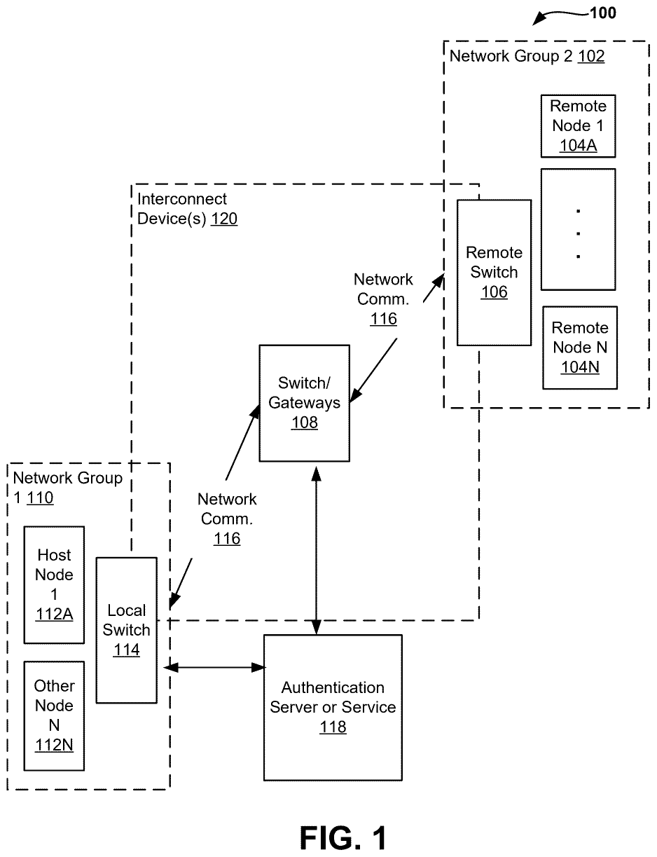

FIG. 1 illustrates a network 100 that is subject to embodiments of using virtual routing and forwarding (VRF) for tenant provisioning. The network 100 supports dynamic association of a tenant with its related VRF information using a switch. For instance, level 2 (L2)-based signaling may not be naturally useful for level 3(L3 ) networking and may impose limitations to internet protocol (IP) addressing. The dynamic association may be made by signaling or using a VRF reference (such as a VRF name) associated with a tenant's provisioning request, and which may be an L3 construct, as part of an 802.1X authentication process. In one example, the VRF reference may be used instead of an L2 attribute (such as a virtual local area network (VLAN) identifier (ID)) to be bound to an L3 entity. The VRF reference may be used, on behalf of a tenant and as part of a provisioning of resources for the tenant, to place the tenant with a VRF, such as a VRF instance, associated with the VRF reference. The VRF may include a logical instance of a routing table to allow multiple independent routing tables to coexist on a single physical device, providing isolation and security between different traffic flows for different tenants. As such, reference to the VRF is interchangeably used with a VRF instance herein. The placement of the tenant with a VRF allows isolation and security for traffic flows of the tenant, without use of a VLAN ID and creation of a switch virtual interface (SVI) for the VLAN ID to manage Internet Protocol (IP) addressing and routing for a VLAN specific for a tenant. The placement of the tenant with a VRF based in part on a request for the VRF reference also represents automatic tenant clustering in large multi-tenant clusters as there is no requirement for updating the switches based in part on creation of SVIs, in one example.

In one example, the network 100 may include at least one circuit that may be an execution unit of a processor that may be within a switch 106; 114, any one of different interconnect devices 120, or an authentication server or service 118. An interconnect device may allow communication across a wider network group and may include different switches 106 and/or gateways 108, whereas communications in a narrower network group or within a network group may be enabled by at least one switch 106, 114. The switches may communicate with each other independently of the nodes to share configuration information for various routes in the network 100. the switches may also communicate independently with the authentication server or service 118 to perform authentication or to perform provisioning of resources for a tenant.

The switch 106; 114 may be associated with a respective one rack, chassis, or other form of a physical collection illustrated as network group 2 102; 1 110 of nodes or other endpoints 1-N 104A-N; 1-N 112A-N, as illustrated. The tenant provisioning using VRF may be performed for one or more of the network devices, generally referenced by reference numerals 106, 108, 114, 120, and using the authentication server or service 118. The authentication server or service 118 may be a Remote Authentication Dial-In User Service (RADIUS) server. The authentication server or service 118 may include or support network protocol used to authenticate and authorize users. The authentication server or service 118 may centralize authentication, authorization, and accounting functions for a network 100.

The network 100 may include at least a switch or gateway 108, as part of one or more interconnect devices 120, to provide communications 116 between multiple switches 106, 114 and, therefore, between the first or second group nodes 1-N 104A-N, 1-N 112A-N across a wider network group. The approaches for tenant provisioning using VRF may be performed within a network group or between network groups. Therefore, descriptions herein to an interconnect device 120 may be understood as applicable using any of the switches 106, 114 or gateways 108 illustrated. Any communications network supporting Transmission Control Protocol (TCP) or Internet Protocol (IP) on top of TCP, may be used with the tenant provisioning using VRF described herein. In some examples, the network 100 is part of or supports large multi-tenant clusters, provided as host nodes 112A-112N and 104A-104N. As such, the network 100 may be part of a multi-tenant environment with the host nodes 112A-112N and 104A-104N allowing or supporting tenancy of tenants of the multi-tenant environment. In some examples, at least each network group 102, 110 may represent a cluster of the multi-tenant clusters herein.

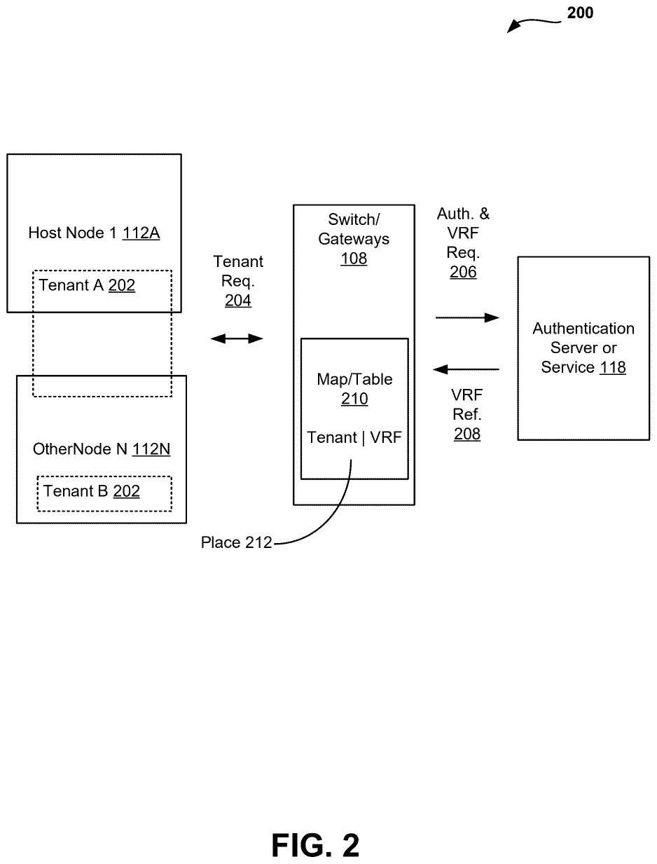

FIG. 2 illustrates network aspects 200 for using VRF for tenant provisioning, in one example. The illustrated host nodes 1 112A-N112N may include physical servers that are part of underlying infrastructure for virtualized environments and that may be subject to provisioning for one or more tenants 202. The provisioning process for infrastructure that may include at least one of the host nodes 1 112A-N112N may include performing a physical setup to acquire and configure the host nodes 1 112A-N112N. This may include installing operating systems, network interfaces, and storage devices. The provisioning process may include resource allocation using resources underlying the infrastructure, including assigning of resources such as a central processing unit (CPU), memory, and storage for a node. The provisioning process may include network configuration for configuring network settings, including IP addresses, VLANs, and routing protocols. The provisioning process may include virtualization by installation of a hypervisor or other agents and drivers in support thereof. The provisioning process may include setting up a security configuration, including firewall rules, intrusion detection systems, and access controls.

Once the infrastructure is provided, tenant provisioning may include creation and configuration associated with virtual environments for individual tenants or customers using the infrastructure. This process may include resource allocation using one or more virtual resources (CPU, memory, storage, and network bandwidth) to the tenant 202; Virtual Machine (VM) creation with specified resources and configured operating systems (OSs); network configuration for virtual networks, IP addresses, and routing for the VMs; storage provisioning by allocating storage space for tenant data, security configuration within the virtualization spaces.

A tenant 202 may be connected to an interconnect device 120, such as a switch or gateway 108. Although referenced as a switch or a gateway 108, the discussion herein may be applicable to each of the network devices marked with reference numerals 106, 108, 114, 120 in FIG. 1. The tenant 202 may request 204 to be placed in a VRF (associated with an L3 virtual routing and a forwarding context). In at least one example, the request 204 may be a request for provisioning and the placement with the VRF may occur as part of the provisioning. The placement 212 is also on behalf of a tenant 202 and as part of a provisioning of resources for the tenant 202. The placement 212 may be in the form of a map or table 210, as illustrated. Thereafter, placement of the tenant with the VRF allows isolation and security for traffic flows of the tenant to the specific VRF.

The switch 108 may be able to support VRF provisioning. In one example, the tenant's request 204 may trigger the switch 108 to request authentication and to provide a VRF request 206 to an authentication server or service 118. The authentication server or service 118 may be able to receive and retain VRF information from one or more switches 108 in the network 100. The authentication server or service 118 may be able to return a VRF reference to the switch 108. The VRF reference may be a VRF name for a tenant. The switch 108 may get the VRF reference 208 and may use it to place the tenant in its VRF that is associated with the VRF reference 208. As the VRF reference 208 is native to L3, there is no requirement for specialized capabilities other than configuration within the switches 108 to recognize the VRF reference 208 and within the authentication server or service 118 to provide the VRF reference 208.

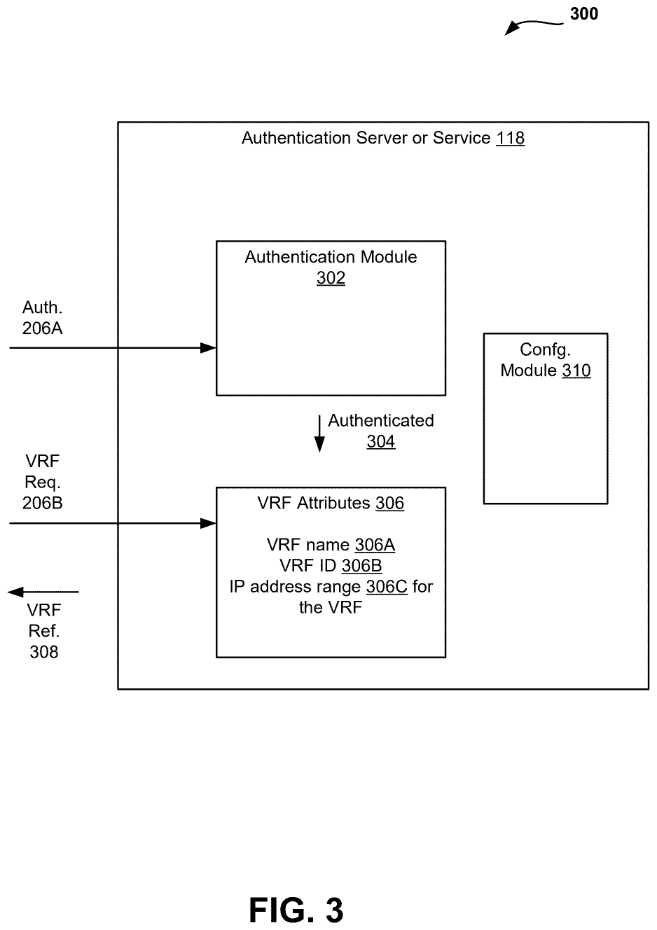

FIG. 3 illustrates modules 300 of an authentication server to support the use of VRF for tenant provisioning, in one example. An authentication server or service 118 may include or may be associated with an authentication module 302 which may be used to ensure that authorized users (such as tenants) are able to access network resources of the host nodes 1 112A-N112N by enforcing authentication and authorization policies. The authentication module 302 may be able to process authentication requests from network access servers (NAS) or the host nodes 1 112A-N112N. The authentication module 302 may verify a user's credentials against a configured authentication source (such as an LDAP (Lightweight Directory Access Protocol) or other database). The authentication module 302 may be able to send an authentication response to the NAS and may indicate authentication 304 results for a VRF attributes module 306. VRF attributes may include VRF references (such as a name 306A, an ID 306B), and IP address ranges 306C for the VRF.

The authentication server or service 118 may include a configuration (config.) module 118A to allow administration and configuration to the authentication server or service 118. The administration and configuration may be as to authentication methods, authorization policies, and accounting parameters within the authentication server or service 118. The VRF request 206B may be matched to a VRF reference (such as VRF name 306A or its identifier 306B).

In at least one example, the use of the VRF is an L3 construct and may represent an independent routing instance of multiple routing instances on shared infrastructure. The VRF is able to isolate different routing domains and is able to allow security and flexibility in the network 100. This represents a departure from using L2 SVI that may rely more on IP routing of a switch. The SVI may create a virtual interface that represents a VLAN but doing so may require updating of a switch for each provisioning performed so that multiple VLANs can coexist on a single physical switch, to allow inter-VLAN routing. The VRF being mapped or tabled (or otherwise placed) with the tenant allows provisioning to proceed with the flows routed by IP-based instances instead of VLANs.

FIGS. 1-3 illustrate that a network 100 may include network devices 106, 108, 114, 120 and an authentication server or service 118. Any of the network devices may provide an authentication request and a VRF request to the authentication server or service 118. The authentication server or service 118 may return a VRF reference to the network device. The network device may further, on behalf of a tenant 202 and as part of a provisioning of resources for the tenant 202, place 212 the tenant 202 with a VRF instance associated with the VRF reference, as detailed further in connection with one or more of FIGS. 2 and 3.

In some examples, the network 100 may be such that each of the network devices performing the authentication request or the VRF request is a single physical device. The VRF instance 208 returned from authentication server or service 118 may include or allow a logical instance of a routing table, along with multiple independent routing tables, to coexist on the network device. In some examples, the multiple independent routing tables may allow or provide isolation and security between different traffic flows for different tenants within the network 100 and through the network device 106, 108, 114, 120.

In some examples, placement 212 of the tenant with the VRF instance allows isolation and security for traffic flows of the tenant in the absence of a VLAN ID and in the absence of an SVI for the VLAN ID to manage IP addressing and routing for a VLAN specific for the tenant. In some examples, placement 212 of the tenant with the VRF instance may be based in part on a request for the VRF reference. This may be as part of an automatic tenant clustering in large multi-tenant clusters.

In some examples, placement 212 of the tenant with the VRF instance may be based in part on dynamic association between the tenant and the VRF instance. The dynamic association may include association of the VRF reference with the tenant as part of a provisioning performed in response to a request 204 by the tenant. The VRF reference may be a VRF name 306A or a VRF ID 306B which may be retained, along with an IP address range 306F for the VRF reference or the VRF. The retention may be in the authentication server or service 118, as illustrated and described in connection with one or more of FIGS. 1-3.

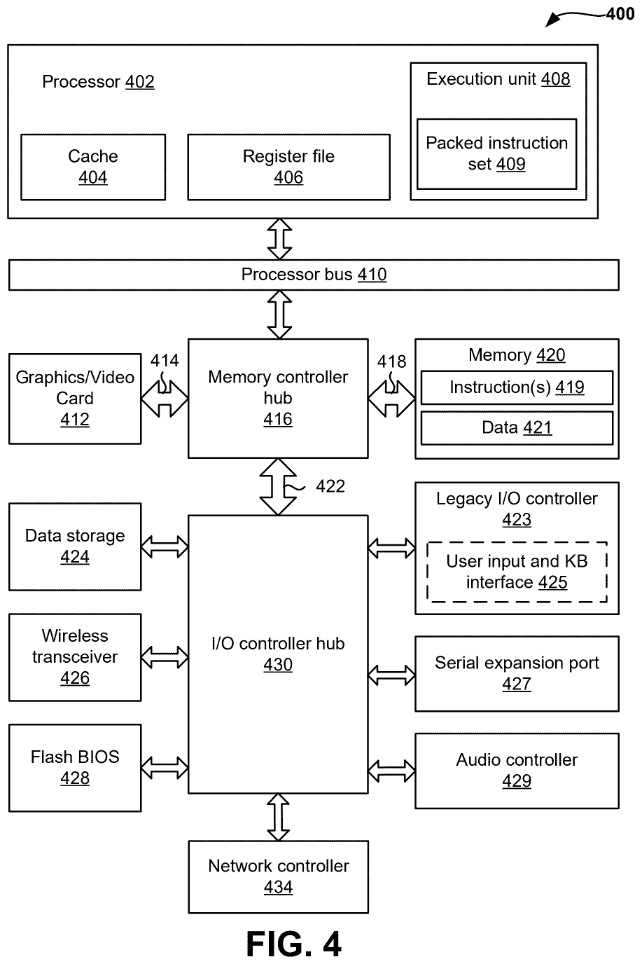

FIG. 4 illustrates computer and processor aspects 400 of a system for using VRF for tenant provisioning, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, data processing units (DPUs), and graphics processing units (GPUs) and may be within a switch 106; 114, any one of different interconnect devices 120, or first or second group nodes 1-N 104A-N; 1-N 112A-N, as described all throughout herein.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside externally to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating-point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

In at least one embodiment, the system in FIGS. 1-4 therefore include one or more execution units 408 within a switch 106; 114, any one of different interconnect devices 120, or first or second group nodes 1-N 104A-N; 1-N 112A-N to support convergence optimization. For example, at least one execution unit 408 supports convergence optimization in other processing units of the other host machines (or nodes). The at least one execution unit 408 is part of one or more circuits which are to be associated as nodes in a network. For example, the at least one execution unit 408 of a processor may be a circuit that is to be part of a node with another circuit of another processor in a different node.

As such, the one or more circuits of at least one execution unit 408 may be able to provide an authentication request and a VRF request for authentication and for a VRF reference. The one or more circuits of at least one execution unit 408 may receive the VRF reference. The one or more circuits may be further able to, on behalf of a tenant and as part of a provisioning of resources for the tenant, place the tenant with a VRF instance associated with the VRF reference.

The one or more circuits of at least one execution unit 408 may be part of a single physical device, such as a network device. The VRF instance may include a logical instance of a routing table, along with multiple independent routing tables, which coexist on the single physical device. There may be multiple independent routing tables to allow or provide isolation and security between different traffic flows for different tenants within a network and through the single physical device. In some examples, placement of the tenant with the VRF instance allows isolation and security for traffic flows of the tenant in the absence of a VLAN ID and in the absence of an SVI for the VLAN ID to manage IP addressing and routing for a VLAN specific for the tenant. In some examples, placement of the tenant with the VRF instance may be based in part on a request for the VRF reference, as part of an automatic tenant clustering in large multi-tenant clusters. In some examples, placement of the tenant with the VRF instance may be based in part on dynamic association between the tenant and the VRF instance. The dynamic association may include association of the VRF reference with the tenant as part of a provisioning performed in response to a request by the tenant. In some examples, the VRF reference is a VRF name or a VRF ID which is retained, along with a range of IP addresses for the VRF reference, by an authentication server or service which is to perform the authentication for the authentication request.

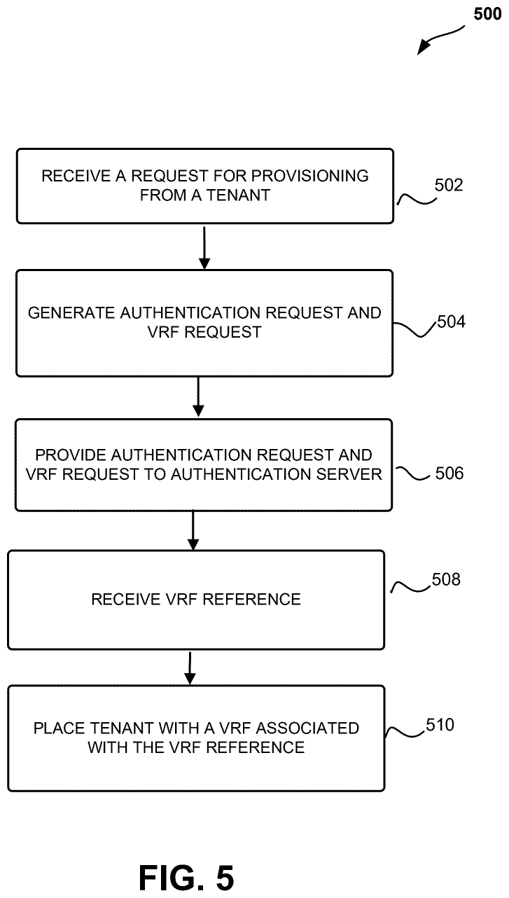

FIG. 5 illustrates a process flow or method 500 in a system for using VRF for tenant provisioning, in one example. The method 500 may include a step to receive 502 a request for provisioning from a tenant. The method 500 may include a step to generate 504 an authentication request and a VRF request. The step to generate 504 may occur in response to the request in the step to receive 502 the request. The method 500 may include a step to provide 506 the authentication request and the VRF request to an authentication server. The method 500 may include a step to receive 508 a VRF reference and to place 510 the tenant with a VRF associated with the VRF reference.

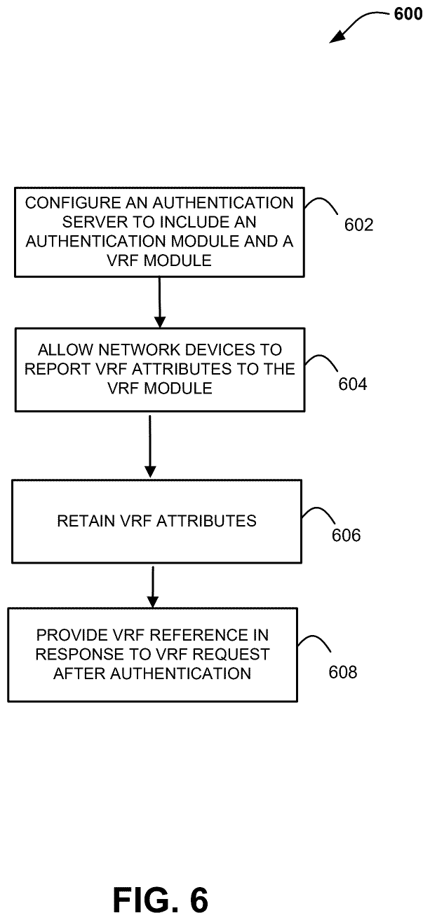

FIG. 6 illustrates yet another process flow or method 600 for an authentication server to support tenant provisioning, in one example. The method 600 may be in support of the method 500 in FIG. 5. For example, the method 600 may include a step to configure 602 an authentication server to include an authentication module and a VRF module. The method 600 may include a step to allow 604 network devices to report VRF attributes to the VRF module. The method 600 may include a step to retain 606 the VRF attributes. The method 600 may include a step to provide 608 the VRF reference in response to VRF request after authentication.

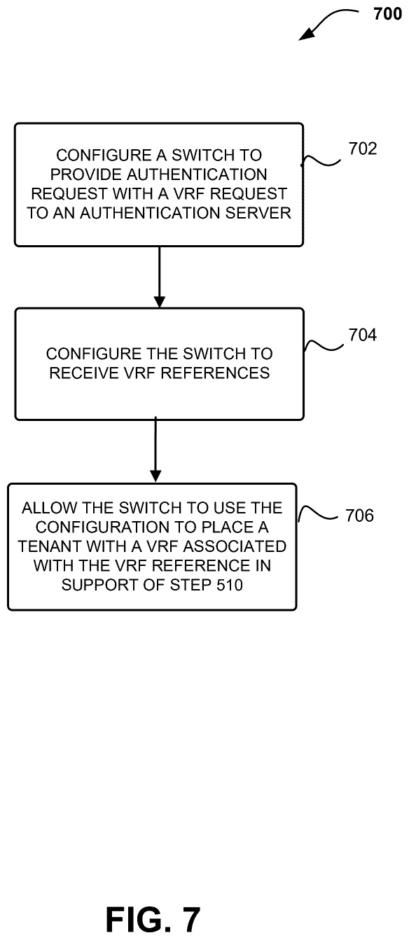

FIG. 7 illustrates a further process flow for a switch to support tenant provisioning, in one example. The method 700 may be in support of one or more of the method 500 in FIG. 5 or the method 600 in FIG. 6. For example, the method 700 may include a step to configure 702 a switch to provide authentication request with a VRF request to an authentication server. The method 700 may include a step to configure 704 the switch to receive VRF references. The method 600 may include a step to allow 706 the switch to use the configuration to place a tenant with a VRF associated with the VRF reference in support of step 510.

In some examples, one or more of the methods 500, 600, 700 may include a step or a sub-step for allowing multiple independent routing tables to coexist on a single physical device and as logical instances. The multiple independent routing tables may include a routing table of the VRF instance. One or more of the methods 500, 600, 700 may include a step or a sub-step for allowing or providing, using the multiple independent routing tables, isolation and security between different traffic flows for different tenants within the network and through the single physical device. One or more of the methods 500, 600, 700 may include a step or a sub-step for allowing, by the placement of the tenant with the VRF instance, isolation and security for traffic flows of the tenant in the absence of a VLAN ID and in the absence of an SVI for the VLAN ID to manage IP addressing and routing for a VLAN specific for the tenant.

One or more of the methods 500, 600, 700 may include a step or a sub-step for allowing or causing an automatic tenant clustering in large multi-tenant clusters by the placement of the tenant with the VRF instance. This may be based in part on the request for the provisioning from the tenant. One or more of the methods 500, 600, 700 may include a step or a sub-step for performing dynamic association between the tenant and the VRF instance as part of the placement of the tenant with the VRF instance. The dynamic association may include association of the VRF reference with the tenant as part of a provisioning performed in response to a request by the tenant. One or more of the methods 500, 600, 700 may include a step or a sub-step for using a VRF name or a VRF ID as the VRF reference, which is retained, along with a range of IP addresses for the VRF reference, by the authentication server or service.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, the number of items in a plurality is at least two but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of the instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment, combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to the practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, a ‘processor’ may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A network comprising a network device and an authentication server or service, the network device to provide an authentication request and a virtual routing and forwarding (VRF) request to the authentication server or service, and the authentication server or service to return a VRF reference to the network device, wherein the network device is further to, on behalf of a tenant and as part of a provisioning of resources for the tenant, place the tenant with a VRF instance associated with the VRF reference.

2. The network of claim 1, wherein the network device is a single physical device, and wherein the VRF instance comprises or allows a logical instance of a routing table, along with multiple independent routing tables, to coexist on the network device.

3. The network of claim 2, wherein the multiple independent routing tables allow or provide isolation and security between different traffic flows for different tenants within the network and through the network device.

4. The network of claim 1, wherein placement of the tenant with the VRF instance allows isolation and security for traffic flows of the tenant in the absence of a virtual local area network (VLAN) identifier (ID) and in the absence of a switch virtual interface (SVI) for the VLAN ID to manage Internet Protocol (IP) addressing and routing for a VLAN specific for the tenant.

5. The network of claim 1, wherein placement of the tenant with the VRF instance is based in part on a request for the VRF reference, as part of an automatic tenant clustering in large multi-tenant clusters.

6. The network of claim 1, wherein placement of the tenant with the VRF instance is based in part on dynamic association between the tenant and the VRF instance, wherein the dynamic association comprises association of the VRF reference with the tenant as part of a provisioning performed in response to a request by the tenant.

7. The network of claim 1, wherein the VRF reference is a VRF name or a VRF identifier (ID) which is retained, along with a range of Internet Protocol (IP) addresses for the VRF reference, by the authentication server or service.

8. One or more circuits to provide an authentication request and a VRF request for authentication and for a VRF reference, and to receive the VRF reference, wherein the one or more circuits is further to, on behalf of a tenant and as part of a provisioning of resources for the tenant, place the tenant with a VRF instance associated with the VRF reference.

9. The one or more circuits of claim 8, wherein the one or more circuits is part of a single physical device, and wherein the VRF instance comprises or allows a logical instance of a routing table, along with multiple independent routing tables, to coexist on the single physical device.

10. The one or more circuits of claim 9, wherein the multiple independent routing tables allow or provide isolation and security between different traffic flows for different tenants within a network and through the single physical device.

11. The one or more circuits of claim 8, wherein placement of the tenant with the VRF instance allows isolation and security for traffic flows of the tenant in the absence of a virtual local area network (VLAN) identifier (ID) and in the absence of a switch virtual interface (SVI) for the VLAN ID to manage IP addressing and routing for a VLAN specific for the tenant.

12. The one or more circuits of claim 8, wherein placement of the tenant with the VRF instance is based in part on a request for the VRF reference, as part of an automatic tenant clustering in large multi-tenant clusters.

13. The one or more circuits of claim 8, wherein placement of the tenant with the VRF instance is based in part on dynamic association between the tenant and the VRF instance, wherein the dynamic association comprises association of the VRF reference with the tenant as part of a provisioning performed in response to a request by the tenant.

14. The one or more circuits of claim 8, wherein the VRF reference is a VRF name or a VRF identifier (ID) which is retained, along with a range of Internet Protocol (IP) addresses for the VRF reference, by an authentication server or service which is to perform the authentication for the authentication request.

15. A method for a network, comprising:
receiving a request for provisioning from a tenant;
generating an authentication request and a VRF request;
providing the authentication request and the VRF request to an authentication server;
receiving a VRF reference; and
placing the tenant with a VRF instance associated with the VRF reference.

16. The method of claim 15, further comprising:
allowing multiple independent routing tables to coexist on a single physical device and as logical instances, the multiple independent routing tables comprising a routing table of the VRF instance.

17. The method of claim 16, further comprising:
allowing or providing, using the multiple independent routing tables, isolation and security between different traffic flows for different tenants within the network and through the single physical device.

18. The method of claim 15, further comprising:
allowing, by the placement of the tenant with the VRF instance, isolation and security for traffic flows of the tenant in the absence of a virtual local area network (VLAN) identifier (ID) and in the absence of a switch virtual interface (SVI) for the VLAN ID to manage IP addressing and routing for a VLAN specific for the tenant.

19. The method of claim 15, further comprising:
allowing or causing an automatic tenant clustering in large multi-tenant clusters by the placement of the tenant with the VRF instance, based in part on the request for the provisioning from the tenant.

20. The method of claim 15, further comprising one or more of:
performing dynamic association between the tenant and the VRF instance as part of the placement of the tenant with the VRF instance, wherein the dynamic association comprises association of the VRF reference with the tenant as part of a provisioning performed in response to a request by the tenant; or
using a VRF name or a VRF identifier (ID) as the VRF reference, which is retained, along with a range of IP addresses for the VRF reference, by the authentication server or service.
